(19) United States
(12) Patent Application Publication
(10) Pub. No.: US 2021/0278078 A1
(43) Pub. Date: Sep. 9, 2021

(54) BOILER COAL SAVING CONTROL METHOD

(71) Applicant: XIAMEN ETOM SOFTWARE TECHNOLOGY CO., LTD., Xiamen City, Fujian (CN)

(72) Inventors: Yu LIU, Xiamen City (CN); Zailian SUN, Xiamen City (CN); Yu MEI, Xiamen City (CN)

(21) Appl. No.: 17/260,549

(22) PCT Filed: May 30, 2019
(86) PCT No.: PCT/CN2019/089211

§ 371 Date: Jan. 14, 2021

(30) Foreign Application Priority Data
Jul. 18, 2018 (CN) 201810788738.7

(51) Int. Cl. F22B 35/18; F23N 5/26; F23N 1/02; G06N 20/00

(52) U.S. Cl. CPC F22B 35/18; F23N 5/265; F23N 1/022; F23N 2900/05006; F23N 2237/00; F23N 2241/10; G06N 20/00

(57) ABSTRACT

A boiler coal saving control method includes a linear relation model creating step, an optimization target determination step, and a machine learning step. The linear relation model creating step includes creating a multi-grade model grading mechanism and creating linear relation models accordingly so as to fill an empty set in a data set. The multi-grade model grading mechanism includes performing primary grading based on boiler load, coal quality, and ambient temperature, and secondary grading based on boiler load. The optimization target determination step includes determining a boiler optimization target that includes boiler combustion efficiency and a nitrate concentration control value for flue gas. The machine learning step performs machine learning according to a data source and includes a model numbering sub-step, an ontology determination sub-step, and a target optimization sub-step. The control method uses machine learning to provide an operation recommendation for improving boiler combustion efficiency and thereby saving coal.

### BACKGROUND OF THE INVENTION

### 1. Technical Field

The invention pertains to the field of electronic technology. More particularly, the invention relates to a boiler coal saving control method.

### 2. Description of Related Art

One major issue for thermal power stations is to make economic use of coal in boilers. The key link in coal saving control is to obtain the environmental parameters in the combustion chamber of a boiler in real time, and only when such parameters are obtained in real time can coal saving control be achieved. Given the harsh environment in a combustion chamber, it is required that the detection nodes in a combustion chamber be adequately protected and capable of obtaining the to-be-detected parameters accurately; otherwise, it is impossible to know the exact combustion state of the boiler, let alone exercise coal saving control effectively.

A technique for virtually reconstructing the combustion state in a combustion chamber has been proposed in the prior art. This technique entails analyzing the laser spectra of a network of laser measurement sensors in order to reconstruct the combustion state in a combustion chamber. While the technique can produce satisfactory detection results and provide guidance on combustion optimization, the network is composed of over a hundred laser measurement sensors, each costing more than three hundred thousand CNY. The entire system, therefore, incurs a prohibitively high cost, which prevents extensive use of the technique.

### BRIEF SUMMARY OF THE INVENTION

In view of the aforesaid drawback of the prior art, one objective of the invention is to provide a boiler coal saving control method that uses machine learning to estimate the environmental parameters in the combustion chamber of a boiler so that the environmental parameters in the combustion chamber can be obtained at low cost.

To achieve the foregoing objective, the invention provides a boiler coal saving control method that includes a linear relation model creating step, an optimization target determination step, and a machine learning step.

The linear relation model creating step is used to create a multi-grade model grading mechanism and create linear relation models accordingly so as to fill an empty set in a data set. The multi-grade model grading mechanism includes performing primary grading while taking three characteristic values in the basic working conditions of a boiler, namely boiler load, coal quality, and ambient temperature, as grading indexes, and performing secondary grading based on boiler load.

Boiler load is graded at an interval of 50 MW. Coal quality is graded according to per-ton-of-coal power, wherein per-ton-of-coal power=useful power/quantity of coal fed. Ambient temperature is graded based on a seasonal index or the temperature of the circulating water.

To carry out secondary grading based on boiler load, one of the characteristic values used in primary grading, namely the boiler load, is further subjected to secondary grading, in which the boiler load is further divided by an interval of 1 MW so as to determine the linear relation model created for the following boiler parameters: the boiler load, the instantaneous coal feeding rate of each coal pulverizer, the cold primary air damper opening of each coal pulverizer, the hot primary air damper opening of each coal pulverizer, the combined air damper opening, the frequency conversion instruction and baffle plate opening of each primary exhauster, the swing angle and opening of each of four upper overfire air ports, and the swing angle and opening of each of four lower overfire air ports. The linear relation model is then used in conjunction with a partial differentiation theorem to fill the empty set in the data set.

The optimization target determination step is used to determine a boiler optimization target. The boiler optimization target includes the combustion efficiency of the boiler and a control value for the nitrate concentration of flue gas.

More specifically, the optimization target determination step includes: determining the combustion efficiency of the boiler and determining the NOx concentration control value of the boiler. The combustion efficiency of the boiler is determined by first determining if the data source includes a field for combustion efficiency, and if not, calculating a combustion efficiency factor as an alternative to the combustion efficiency of the boiler.

The machine learning step is used to perform machine learning according to the data source and includes a model numbering sub-step, an ontology determination sub-step, and a target optimization sub-step.

The model numbering sub-step is used to establish a mapping relationship between the basic working conditions and a model so as to determine the model corresponding to the basic working conditions. The model number used in the model numbering sub-step is defined as follows:

Model number=ambient temperature number+boiler load grading number×ambient temperature number weight+per-ton-of-coal power ratio number×boiler load grading number weight×ambient temperature number weight.

Ambient temperature number: According to the invention, either a season or the temperature of the circulating water can be used as an index. When a season is used as the index, the number 0 corresponds to winter, and the number 1 corresponds to summer. When the temperature of the circulating water is used as the index, the temperature of the circulating water is classified into ten grades, whose corresponding numbers are 0-9 respectively.

The ambient temperature number weight is 16.

The boiler load grading number: Boiler load is graded at an interval of 50 MW, and each grade is assigned a number.

The boiler load grading number weight is 16.

Per-ton-of-coal power ratio number=a ceiling/floor function of ((per-ton-of-coal power−lowest per-ton-of-coal power value)/per-ton-of-coal power grading interval).

Per-ton-of-coal power grading interval=(highest per-ton-of-coal power value−lowest per-ton-of-coal power value)/10.

Per-ton-of-coal power=useful power/quantity of coal fed.

The secondary grading of the basic working conditions corresponds to a grade column in the model and preserves a classification example of the model. While preserving the example, a difference method is used to calculate the average variation of each factor per unit variation of boiler load, and each variation obtained is a partial derivative in the direction of the corresponding factor. While generating an optimization solution, if an example corresponding to the current basic working conditions exists, the example is directly used; otherwise, the first example is taken as a reference, and the theoretical value of each factor is calculated according to the difference in boiler load and the partial derivative of the factor.

The ontology determination sub-step is used to determine the states of all the operable pieces of equipment that are related to the combustion efficiency of the boiler. The aforesaid states include: the instantaneous coal feeding rate of each coal pulverizer, the cold primary air damper opening of each coal pulverizer, the hot primary air damper opening of each coal pulverizer, the combined air damper opening, the frequency conversion instruction and baffle plate opening of each primary exhauster, the swing angle and opening of each of the four upper overfire air ports, the swing angle and opening of each of the four lower overfire air ports, the swing angle and opening of each of four tiers of secondary air ports, and the total air flow of the secondary air ports.

The target optimization sub-step is used to generate a sorting rule for the ontologies determined, as detailed below:

when the combustion efficiencies corresponding respectively to two ontologies are both lower than or equal to 97%, the ontology corresponding to the higher combustion efficiency takes precedence over the other;

when the combustion efficiencies corresponding respectively to two ontologies are both higher than 97%, the ontology corresponding to a lower NOx concentration takes precedence over the other; and

when an ontology corresponds to a combustion efficiency lower than or equal to 97% and another ontology corresponds to a combustion efficiency higher than 97%, the ontology corresponding to the combustion efficiency lower than or equal to 97% takes precedence over the other.

If the data source does not include boiler combustion efficiency, the combustion efficiency factor of the boiler is used in place of the combustion efficiency of the boiler, and the sorting rule is modified as follows:

when the combustion efficiency factors corresponding respectively to two ontologies are both lower than or equal to 30, the ontology corresponding to the higher combustion efficiency factor takes precedence over the other;

when the combustion efficiency factors corresponding respectively to two ontologies are both higher than 30, the ontology corresponding to a lower NOx concentration takes precedence over the other; and

when an ontology corresponds to a combustion efficiency factor lower than or equal to 30 and another ontology corresponds to a combustion efficiency factor higher than 30, the ontology corresponding to the combustion efficiency factor lower than or equal to 30 takes precedence over the other, wherein:

combustion efficiency factor=100/|(current flue gas temperature−lowest flue gas temperature standard)*(oxygen content of flue gas−loaded oxygen content factor)|, and

lowest flue gas temperature standard=110° C.

The machine learning step may further include a limitation sub-step for generating, as limitations, a rule of learning prohibition and a rule of no recommendation and for directly deleting ontologies satisfying the rule of learning prohibition or the rule of no recommendation. In one embodiment of the invention, ontologies satisfying the aforesaid limitations include:

the flue temperature being lower than the standard, such as 110° C., or boiler load being lower than 20%; and

the absolute value of the difference between the main steam temperature and its setting or the absolute value of the difference between the primary/secondary reheating temperature and its setting being greater than the design maximum difference.

The machine learning step may further include a stable state screening sub-step for screening out data that change too drastically under dynamic working conditions to stably reflect the relationship between the performance and emissions of the boiler and the operable factors. The stable state screening sub-step covers detection nodes for detecting boiler load, the reheated steam temperature, and the reheated steam pressure, and may also cover detection nodes for detecting one of the main steam temperature, the main steam pressure, and the temperature of the circulating water.

The machine learning step may further include an optimization recommendation sub-step for sorting according to an optimization rule and then displaying an operation solution that, if determined to exist, is superior to the operation used under the current basic working conditions. The optimization rule includes at least one of the following: the instantaneous coal feeding rate of each coal pulverizer, the cold primary air damper opening of each coal pulverizer, the hot primary air damper opening of each coal pulverizer, the combined air damper opening, the frequency conversion instruction and baffle plate opening of each primary exhauster, the swing angle and opening of each of the four upper overfire air ports, the swing angle and opening of each of the four lower overfire air ports, the swing angle and opening of each of the four tiers of secondary air ports, and the total air flow of the secondary air ports.

The advantageous effects of the foregoing technical solution of the invention are as follows: The foregoing technical solution provides a boiler coal saving control method that is intended to boost combustion efficiency, that is based on the precondition of causing no harm, and that analyzes the major factors (coal-related factors and air-related factors) of boiler combustion efficiency by way of big data and artificial intelligence technology so as to obtain an optimization recommendation for enhancing combustion efficiency, thereby achieving the objective of artificial intelligence-assisted decision making regarding economic use of coal. The technical solution requires neither a change in the combustion structure or principle of the boiler nor an addition of detection nodes and, given the prerequisite of not affecting normal production, uses a machine learning method to provide safe, easy-to-follow, and reasonable operation recommendations for improving boiler combustion efficiency and thereby saving coal.

### BRIEF DESCRIPTION OF THE SEVERAL VIEWS OF THE DRAWINGS

FIG. 1 is the flowchart of an embodiment of the invention.

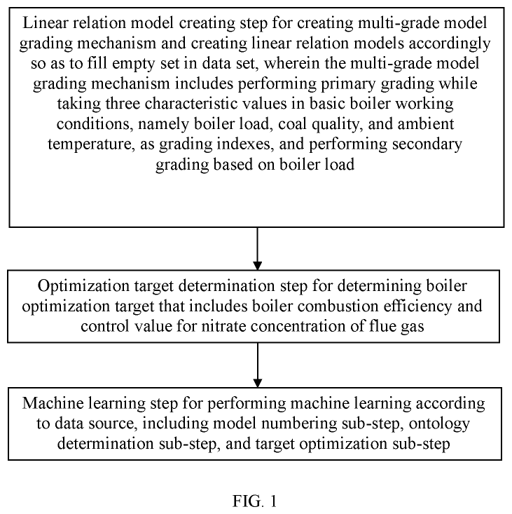

### DETAILED DESCRIPTION OF THE INVENTION

A detailed description of the invention is given below with reference to an embodiment in conjunction with the accompanying drawing.

One embodiment of the invention provides a boiler coal saving control method that is intended to boost combustion efficiency, that is based on the precondition of causing no harm, and that analyzes the major factors (coal-related factors and air-related factors) of boiler combustion efficiency by way of big data and artificial intelligence technology so as to obtain an optimization recommendation for enhancing combustion efficiency, thereby achieving the objective of artificial intelligence-assisted decision making regarding economic use of coal.

The precondition of causing no harm refers to:

1. In terms of the steam turbine(s) driven by the boiler, the solution must not affect the main turbine temperature, the primary reheating temperature, or the secondary reheating temperature;

2. In terms of environmental protection, the flue gas must not have an exceedingly high NOx concentration; and

3. Boiler slagging must not be aggravated.

The technical solution of the invention requires neither a change in the combustion structure or principle of the boiler nor an addition of detection nodes and, given the prerequisite of not affecting normal production, uses a machine learning method to provide safe, easy-to-follow, and reasonable operation recommendations for improving boiler combustion efficiency and thereby saving coal.

To improve the combustion efficiency of a boiler, it is important to know the factors that determine combustion efficiency. A thorough study has indicated that the major factors influencing the combustion efficiency of a boiler include:

1. The structure and combustion principle of the boiler, which constitute an invariable factor;

2. Coal quality;

3. Other coal-related factors, including the way each coal pulverizer is operated, the instantaneous coal feeding rate of each coal pulverizer, and the air flow of each primary air port; and

4. Air-related factors, including the total air flow of the secondary air ports, the swing angle and opening of each overfire air port, and the swing angle and opening of each secondary air port.

As the invariable factor is not applicable to the exercise of boiler coal saving control by monitoring the environmental parameters in the combustion chamber of the boiler, the embodiment disclosed herein considers only those optimizable variable factors when exercising boiler coal saving control to increase boiler combustion efficiency. In addition, to satisfy the precondition of causing no harm, boiler combustion efficiency must be optimized in a harmless manner in order to make economic use of coal.

The precondition of causing no harm includes the following:

1. In terms of the steam turbine(s) driven by the boiler, the solution must not affect the main turbine temperature, the primary reheating temperature, or the secondary reheating temperature;

2. In terms of environmental protection, the flue gas must not have an exceedingly high NOx concentration; and

3. Boiler slagging must not be aggravated.

Under the foregoing precondition, the embodiment disclosed herein provides a boiler coal saving control method that includes a linear relation model creating step, an optimization target determination step, and a machine learning step.

The linear relation model creating step is used to create a multi-grade model grading mechanism and create linear relation models accordingly so as to fill an empty set in a data set. In this embodiment, different optimization models are created for different basic working conditions respectively in order to render the optimization recommendations specific. Also, a two-stage model grading mechanism is established.

The factors chosen from the basic working conditions and the level of grading granularity have a huge impact on the effects of the optimization solutions. The finer the grading granularity, the more accurate the results. An overly fine grading granularity, however, tends to increase the number of empty sets and thus compromise model usability.

This embodiment uses a two-stage grading mechanism that includes primary grading and secondary grading.

The primary grading uses three characteristic values, namely boiler load, coal quality, and ambient temperature, as the grading indexes; grades the basic working conditions on a basic level; and has a relatively coarse grading granularity, which solves problems associated with insufficient samples. The primary grading includes:

1) Grading of coal quality: Coal quality is an important factor, and yet there is no online data about coal quality. In this embodiment, coal quality is represented by per-ton-of-coal power, and per-ton-of-coal power=useful power/quantity of coal fed.

2) Grading of boiler load: Boiler load is graded at an interval of 50 MW.

3) Grading of ambient temperature: Ambient temperature affects combustion efficiency. In this embodiment, ambient temperature may be represented by a seasonal index or the temperature of the circulating water. Test results have shown that the temperature of the circulating water is a more accurate representation than the seasonal index.

The secondary grading further divides one of the characteristic values used in the primary grading. In this embodiment, the characteristic value subjected to the secondary grading is the boiler load. More specifically, the boiler load is further divided by an interval of 1 MW in order to determine the linear relation model created for the following boiler parameters: the boiler load, the instantaneous coal feeding rate of each coal pulverizer, the cold primary air damper opening of each coal pulverizer, the hot primary air damper opening of each coal pulverizer, the combined air damper opening, the frequency conversion instruction and baffle plate opening of each primary exhauster, the swing angle and opening of each of four upper overfire air ports, and the swing angle and opening of each of four lower overfire air ports.

The linear relation model is then used in conjunction with a partial differentiation theorem to fill the empty set in the data set, thereby enhancing not only the calculation precision, but also the usability, of the model. Consequently, problems typical of primary grading are solved.

The optimization target determination step is used to determine a boiler optimization target that includes boiler combustion efficiency and a control value for the nitrate concentration of flue gas.

More specifically, the optimization target determination step includes: determining the combustion efficiency of the boiler and determining the NOx concentration control value of the boiler. To determine the combustion efficiency of the boiler, it is first determined if the data source includes a field for combustion efficiency, and if not, a combustion efficiency factor will be calculated as an alternative to the combustion efficiency of the boiler.

The machine learning step is used to perform machine learning according to the data source and includes a model numbering sub-step, an ontology determination sub-step, a target optimization sub-step, and a limitation sub-step.

The model numbering sub-step is used to establish a mapping relationship between the basic working conditions and a model so as to determine the model corresponding to the basic working conditions. The model number used in the model numbering sub-step is defined as follows:

Model number=ambient temperature number+boiler load grading number×ambient temperature number weight+per-ton-of-coal power ratio number×boiler load grading number weight×ambient temperature number weight.

Ambient temperature number: In this embodiment, either a season or the temperature of the circulating water can be used as an index. When a season is used as the index, the number 0 corresponds to winter, and the number 1 corresponds to summer. When the temperature of the circulating water is used as the index, the temperature of the circulating water is classified into ten grades, whose corresponding numbers are 0-9 respectively.

The ambient temperature number weight is 16.

The boiler load grading number: Boiler load is graded at an interval of 50 MW, and each grade is assigned a number.

The boiler load grading number weight is 16.

Per-ton-of-coal power ratio number=a ceiling/floor function of ((per-ton-of-coal power−lowest per-ton-of-coal power value)/per-ton-of-coal power grading interval).

Per-ton-of-coal power grading interval=(highest per-ton-of-coal power value−lowest per-ton-of-coal power value)/10.

Per-ton-of-coal power=useful power/quantity of coal fed.

The secondary grading of the basic working conditions corresponds to a grade column in the model and preserves a classification example of the model. While preserving the example, a difference method is used to calculate the average variation of each factor per unit variation of boiler load, and each variation obtained is a partial derivative in the direction of the corresponding factor. While generating an optimization solution, if an example corresponding to the current basic working conditions exists, the example is directly used; otherwise, the first example is taken as a reference, and the theoretical value of each factor is calculated according to the difference in boiler load and the partial derivative of the factor.

The ontology determination sub-step is used to determine the states of all the operable pieces of equipment that are related to the combustion efficiency of the boiler. The aforesaid states include: the instantaneous coal feeding rate of each coal pulverizer, the cold primary air damper opening of each coal pulverizer, the hot primary air damper opening of each coal pulverizer, the combined air damper opening, the frequency conversion instruction and baffle plate opening of each primary exhauster, the swing angle and opening of each of the four upper overfire air ports, the swing angle and opening of each of the four lower overfire air ports, the swing angle and opening of each of four tiers of secondary air ports, and the total air flow of the secondary air ports.

The target optimization sub-step is used to generate a sorting rule for the ontologies determined.

If the data source includes boiler combustion efficiency, the sorting rule is as follows:

when the combustion efficiencies corresponding respectively to two ontologies are both lower than or equal to 97%, the ontology corresponding to the higher combustion efficiency takes precedence over the other;

when the combustion efficiencies corresponding respectively to two ontologies are both higher than 97%, the ontology corresponding to a lower NOx concentration takes precedence over the other; and

when an ontology corresponds to a combustion efficiency lower than or equal to 97% and another ontology corresponds to a combustion efficiency higher than 97%, the ontology corresponding to the combustion efficiency lower than or equal to 97% takes precedence over the other.

If the data source does not include boiler combustion efficiency, the combustion efficiency factor of the boiler is used in place of the combustion efficiency of the boiler, and the sorting rule is as follows:

when the combustion efficiency factors corresponding respectively to two ontologies are both lower than or equal to 30, the ontology corresponding to the higher combustion efficiency factor takes precedence over the other;

when the combustion efficiency factors corresponding respectively to two ontologies are both higher than 30, the ontology corresponding to a lower NOx concentration takes precedence over the other; and

when an ontology corresponds to a combustion efficiency factor lower than or equal to 30 and another ontology corresponds to a combustion efficiency factor higher than 30, the ontology corresponding to the combustion efficiency factor lower than or equal to 30 takes precedence over the other.

Combustion efficiency factor=100/|(current flue gas temperature−lowest flue gas temperature standard)*(oxygen content of flue gas−loaded oxygen content factor)|

Lowest flue gas temperature standard=110° C.

The loaded oxygen content factor is determined according to the following table:

| | |
|---|---|
| 0-200 Megawatt (inclusive) | 1.15 |
| 200-300 Megawatt (inclusive) | 1.64 |
| 300-450 Megawatt (inclusive) | 1.55 |
| 450-700 Megawatt (inclusive) | 1.37 |
| 700-900 Megawatt (inclusive) | 1.22 |
| Higher than 900 Megawatt (inclusive) | 1.15 |

The limitation sub-step is used to generate a rule of learning prohibition and a rule of no recommendation and to directly delete ontologies satisfying the rule of learning prohibition or the rule of no recommendation. In this embodiment, ontologies satisfying those rules, or limitations, include:

the flue temperature being lower than the standard, such as 110° C., or the boiler load being lower than 20%; and

the absolute value of the difference between the main steam temperature and its setting or the absolute value of the difference between the primary/secondary reheating temperature and its setting being greater than the design maximum difference.

The machine learning step may further include a stable state screening sub-step for screening out data that change too drastically under dynamic working conditions to stably reflect the relationship between the performance and emissions of the boiler and the operable factors. The stable state screening sub-step covers detection nodes for detecting the boiler load, the reheated steam temperature, and the reheated steam pressure, and may also cover detection nodes for detecting one of the main steam temperature, the main steam pressure, and the temperature of the circulating water.

The machine learning step may further include an optimization recommendation sub-step for sorting according to an optimization rule and then displaying an operation solution that, if determined to exist, is superior to the operation used under the current basic working conditions. The optimization rule includes at least one of the following: the instantaneous coal feeding rate of each coal pulverizer, the cold primary air damper opening of each coal pulverizer, the hot primary air damper opening of each coal pulverizer, the combined air damper opening, the frequency conversion instruction and baffle plate opening of each primary exhauster, the swing angle and opening of each of the four upper overfire air ports, the swing angle and opening of each of the four lower overfire air ports, the swing angle and opening of each of the four tiers of secondary air ports (a total of 16 secondary air ports), and the total air flow of the secondary air ports.

As the optimization recommendation sub-step is subject to limitations on the range of fluctuations of the main turbine temperature, the primary reheating temperature, and the secondary reheating temperature, the performance of the steam turbine(s) driven by the boiler will not be affected. If the target of combustion efficiency factors is set at the equilibrium point or lower, NOx will not be generated to excess. Boiler slagging will not be worse than before either, now that all the recommendations are reproductions of history operations. In addition, as the system includes a rule base generated by the limitation sub-step against improper operations, any new operation recommendation that is found to violate the operation rules will be added to the rule base against improper operations, lest such operations be recommended.

The technical features of the foregoing technical solution are:

1. The establishment of an online knowledge network regarding artificial neural network states:

An online knowledge network is a way in which knowledge points are stored after machine learning. An online knowledge network is advantageous in that it allows fast knowledge retrieval and supports a relatively large number of visits, but is disadvantaged by a large demand for internal storage and relatively stringent requirements for the performance and economy of the storage structure.

2. Exceptional optimization ability:

All the subnetworks of an artificial neural network are capable of optimization; in other words, the root node of each subnetwork is always the optimal solution of the subnetwork. In history-based optimization, therefore, the first node that satisfies the required conditions will be the globally optimal point (in terms of performance and ease of use).

3. The establishment of a negative rule base:

Operations that violate the operation rules are automatically detected according to the negative rule base so that the system will not learn from rule-violating experience or issue rule-violating recommendations.

4. There is no need to label the learning data by human effort. Knowledge will be automatically evaluated and archived according to subsequent working conditions and rules.

While supervised machine learning requires the learning data to be labeled (all the textbooks specify this requirement), the learning data is not necessarily labeled by human effort but can be labeled by the machine instead. In the solution described above, the learning data is automatically labeled (e.g., regarding whether a piece of data being superior to another or constituting rule violation or not).

5. The establishment of data traceability:

A data traceability mechanism is established. The knowledge points of the artificial neural network have an association traceability mechanism so that each recommendation can be traced back to its source of knowledge. A user can check the bases of each recommendation (e.g., power station, machine unit, time, coal quality, basic working conditions, operating conditions, combustion efficiency, and NOx emissions) in order for the recommendation to be more reasonable, safer, and more reliable.

The embodiment described above is only a preferred one of the invention. It should be pointed out that a person of ordinary skill in the art may improve or modify the embodiment in various ways without departing from the principle of the invention. All such improvements and modifications should fall within the scope of the patent protection sought by the applicant.

What is claimed is:

1. A boiler coal saving control method, characterized by comprising a linear relation model creating step, an optimization target determination step, and a machine learning step, wherein:
the linear relation model creating step is used to create a multi-grade model grading mechanism and create linear relation models accordingly so as to fill an empty set in a data set, and the multi-grade model grading mechanism comprises: performing primary grading while taking three characteristic values in basic working conditions of a boiler, namely boiler load, coal quality, and ambient temperature, as grading indexes, and performing secondary grading based on the boiler load;
wherein the boiler load is graded at an interval of 50 MW; the coal quality is graded according to per-ton-of-coal power, wherein the per-ton-of-coal power=useful power/quantity of coal fed; and the ambient temperature is graded based on a seasonal index or a temperature of circulating water;
wherein to carry out the secondary grading based on the boiler load, one of the characteristic values used in the primary grading, namely the boiler load, is further subjected to the secondary grading, in which the boiler load is further divided by an interval of 1 MW so as to determine a said linear relation model created for the following boiler parameters: the boiler load, an instantaneous coal feeding rate of each coal pulverizer, a cold primary air damper opening of each said coal pulverizer, a hot primary air damper opening of each said coal pulverizer, a combined air damper opening, a frequency conversion instruction and baffle plate opening of each primary exhauster, a swing angle and opening of each of four upper overfire air ports, and a swing angle and opening of each of four lower overfire air ports; and the linear relation model is subsequently used in conjunction with a partial differentiation theorem to fill the empty set in the data set;
the optimization target determination step is used to determine a boiler optimization target, the boiler optimization target comprises combustion efficiency of the boiler and a control value for a nitrate concentration of flue gas, and the optimization target determination step comprises:
determining the combustion efficiency of the boiler by first determining if a data source comprises a field for combustion efficiency, and if not, calculating a combustion efficiency factor as an alternative to the combustion efficiency of the boiler; and
determining a NOx concentration control value of the boiler;
the machine learning step is used to perform machine learning according to the data source and comprises a model numbering sub-step, an ontology determination sub-step, and a target optimization sub-step;
wherein the model numbering sub-step is used to establish a mapping relationship between the basic working conditions and a said model so as to determine a said model corresponding to the basic working conditions, wherein:
a model number=an ambient temperature number+a boiler load grading number×an ambient temperature number weight+a per-ton-of-coal power ratio number×a boiler load grading number weight×an ambient temperature number weight;
the ambient temperature number uses either a season or the temperature of the circulating water as an index, wherein when the season is used as the index, the numbers 0 and 1 correspond to winter and summer respectively, and when the temperature of the circulating water is used as the index, the temperature of the circulating water is classified into ten grades, whose corresponding numbers are 0-9 respectively;
the ambient temperature number weight=16;
the boiler load grading number is determined by grading the boiler load at an interval of 50 MW and assigning a number to each grade of the boiler load;
the boiler load grading number weight=16;
the per-ton-of-coal power ratio number=a ceiling/floor function of ((the per-ton-of-coal power−a lowest per-ton-of-coal power value)/a per-ton-of-coal power grading interval);
the per-ton-of-coal power grading interval=(a highest per-ton-of-coal power value−the lowest per-ton-of-coal power value)/10;
the per-ton-of-coal power=the useful power/the quantity of coal fed;
the secondary grading of the basic working conditions corresponds to a grade column in the model and preserves a classification example of the model; while preserving the example, a difference method is used to calculate an average variation of each factor per unit variation of the boiler load, and each said variation is a partial derivative in a direction of a corresponding said factor; and while generating an optimization solution, a said example corresponding to the current basic working conditions is directly used if existing; otherwise, a first said example is taken as a reference, and a theoretical value of each said factor is calculated according to a boiler load difference and a partial derivative of the each said factor;
wherein the ontology determination sub-step is used to determine states of all operable pieces of equipment that are related to the combustion efficiency of the boiler, and the sates comprise: the instantaneous coal feeding rate of each said coal pulverizer, the cold primary air damper opening of each said coal pulverizer, the hot primary air damper opening of each said coal pulverizer, the combined air damper opening, the frequency conversion instruction and baffle plate opening of each said primary exhauster, the swing angle and opening of each of the four upper overfire air ports, the swing angle and opening of each of the four lower overfire air ports, a swing angle and opening of each of four tiers of secondary air ports, and a total air flow of the secondary air ports; and
wherein the target optimization sub-step is used to generate a sorting rule for ontologies, the sorting rule being as follows:
when combustion efficiencies corresponding respectively to two said ontologies are both lower than or equal to 97%, the ontology corresponding to the higher combustion efficiency takes precedence over the other;
when combustion efficiencies corresponding respectively to two said ontologies are both higher than 97%, the ontology corresponding to a lower NOx concentration takes precedence over the other; and
when a said ontology corresponds to a combustion efficiency lower than or equal to 97% and another said ontology corresponds to a combustion efficiency higher than 97%, the ontology corresponding to the combustion efficiency lower than or equal to 97% takes precedence over the other; and
if the data source does not include the combustion efficiency of the boiler, the combustion efficiency factor of the boiler is used in place of the combustion efficiency of the boiler, and the sorting rule is modified as follows:
when said combustion efficiency factors corresponding respectively to two said ontologies are both lower than or equal to 30, the ontology corresponding to the higher combustion efficiency factor takes precedence over the other;
when said combustion efficiency factors corresponding respectively to two said ontologies are both higher than 30, the ontology corresponding to a lower NOx concentration takes precedence over the other; and
when a said ontology corresponds to a said combustion efficiency factor lower than or equal to 30 and another said ontology corresponds to a said combustion efficiency factor higher than 30, the ontology corresponding to the combustion efficiency factor lower than or equal to 30 takes precedence over the other, wherein:
the combustion efficiency factor=100/|(a current flue gas temperature−a lowest flue gas temperature standard)*(oxygen content of the flue gas−a loaded oxygen content factor)|, and
the lowest flue gas temperature standard=110° C.

2. The boiler coal saving control method of claim 1, wherein the machine learning step further comprises:
a limitation sub-step for generating, as limitations, a rule of learning prohibition and a rule of no recommendation and for directly deleting said ontologies satisfying the rule of learning prohibition or the rule of no recommendation, wherein said ontologies satisfying the limitations comprise:
a flue temperature being lower than 110° C., or the boiler load being lower than 20%; and
an absolute value of a difference between a main steam temperature and a setting thereof or an absolute value of a difference between a primary/secondary reheating temperature and a setting thereof being greater than a design maximum difference.

3. The boiler coal saving control method of claim 1, wherein the machine learning step further comprises:
a stable state screening sub-step for screening out data that change too drastically under dynamic working conditions to stably reflect a relationship between performance and emissions of the boiler and operable factors, wherein the stable state screening sub-step covers detection nodes for detecting the boiler load, a reheated steam temperature, a reheated steam pressure, and if necessary, one of a main steam temperature, a main steam pressure, and the temperature of the circulating water.

4. The boiler coal saving control method of claim 1, wherein the machine learning step further comprises:
an optimization recommendation sub-step for sorting according to an optimization rule and then displaying an operation solution that, if determined to exist, is superior to an operation used under the current basic working conditions, wherein the optimization rule comprises at least one of the following: the instantaneous coal feeding rate of each said coal pulverizer, the cold primary air damper opening of each said coal pulverizer, the hot primary air damper opening of each said coal pulverizer, the combined air damper opening, the frequency conversion instruction and baffle plate opening of each said primary exhauster, the swing angle and opening of each of the four upper overfire air ports, the swing angle and opening of each of the four lower overfire air ports, the swing angle and opening of each of the four tiers of secondary air ports, and the total air flow of the secondary air ports.
